(19) United States
(12) Patent Application Publication
(10) Pub. No.: US 2007/0114005 A1
(43) Pub. Date: May 24, 2007

(54) Heat exchanger assembly for fuel cell and method of cooling outlet stream of fuel cell using the same

(76) Inventors: Matthias Bronold, Berlin (DE); Stefan Mergel, Berlin (DE); Mario Breithecker, Berlin (DE)

Correspondence Address: KNOBBE MARTENS OLSON & BEAR LLP, 2040 MAIN STREET, FOURTEENTH FLOOR, IRVINE, CA, 92614, US

(21) Appl. No.: 11/601,483

(22) Filed: Nov. 17, 2006

(30) Foreign Application Priority Data
Nov. 18, 2005 (DE) 102005056181.0
Nov. 2, 2006 (KR) 10-2006-0108021

(51) Int. Cl. F24F 7/00; H01M 8/04; F28F 9/04

(52) U.S. Cl. 165/59; 429/26; 165/178

(57) ABSTRACT

Provided are a heat exchanger assembly and a method of cooling the outlet stream of a fuel cell using the heat exchanger assembly, which increase the efficiency of heat exchange in fuel cell systems. The heat exchanging assembly for fuel cell systems comprising a heat exchanger and a ventilation unit for cooling the heat exchanger, wherein the heat exchanger comprises: an inlet manifold with an inlet opening, an outlet manifold with an outlet opening, and a plurality of heat exchanging elements disposed between the inlet opening of the inlet manifold and the outlet opening of the outlet manifold and connecting the inlet manifold and the outlet manifold, wherein cooling air generated by the ventilation unit flows in the opposite direction to the flow of a medium within the heat exchanging elements.

### CROSS-REFERENCE TO RELATED PATENT APPLICATION

This application claims the benefit of German Patent Application No. 102005056181.0, filed on 18 Nov. 2005 in the German Patent Office, and Korean Patent Application No. 10-2006-0108021, filed on 2 Nov. 2006, in the Korean Intellectual Property Office, the disclosures of which are incorporated herein in their entirety by reference.

### BACKGROUND OF THE INVENTION

1. Field of the Invention

The present invention relates to a heat exchanger assembly and a method of cooling the outlet stream of a fuel cell using the heat exchanger assembly. In particular, the present invention relates to heat exchangers which are used as water condensers in fuel cell systems, especially in Direct Methanol Fuel Cell (DMFC) Systems, used for supplying power for mobile electronic devices.

2. Description of the Related Art

A fuel cell is an electrochemical device producing electricity from an external fuel supply of hydrogen and oxygen. Typical reactants used in a fuel cell are hydrogen on the anode side and oxygen on the cathode side. Fuel cells are often considered to be very attractive in modern applications for their high efficiency and ideally emission-free use. In principle, the only by-product of a hydrogen fuel cell is water vapor. There are several different types of fuel cells, each using a different chemistry. Fuel cells are usually classified by the type of electrolyte they use. Some types of fuel cells work well for use in stationary power generation plants. Others may be useful for small portable applications or for powering cars.

In a hydrogen/oxygen proton-exchange membrane (or “polymer electrolyte”) fuel cell (PEMFC), a proton-conducting polymer membrane separates anode and cathode sides. Each side has an electrode, typically carbon paper coated with a platinum catalyst. On the anode side, hydrogen diffuses to the anode catalyst where it dissociates into protons and electrons. The protons are conducted through the membrane to the cathode, but the electrons are forced to travel in an external circuit, supplying power, because the membrane is electronically insulating. On the cathode catalyst, oxygen molecules react with the electrons which have travelled through the external circuit and with the protons to form water. In this example, the only waste product is water vapor and/or liquid water.

Other fuels are natural gas, propane and methanol. Methanol is a liquid fuel easy to transport and distribute, so methanol may be a likely candidate to power portable devices. A Direct Methanol Fuel Cell (DMFC) relies upon the oxidation of methanol on a catalyst layer to form carbon dioxide. Water is consumed at the anode and is produced at the cathode. Protons (H⁺) are transported across the proton exchange membrane to the cathode where they react with oxygen to produce water. Electrons are transported via an external circuit from anode to cathode providing power to external devices. DMFCs have the advantage that they do not require the use of a reformer to extract hydrogen from the fuel. This allows DMFCs to have a compact design so they can be used in, e.g., mobile telecommunication devices.

In detail, the DMFC is composed of an anode, a cathode and an electrolyte film sandwiched between the anode and the cathode. A methanol aqueous solution is employed as the fuel. A fuel supply is connected with the fuel cell to supply fuel to the anodes. An air supply supplies air to the cathodes. A heat exchanger is connected to a cathode exhaust for cooling an exhaust stream, condensing water from an exhaust gas, and discharging the water to be mixed with the fuel. The condensed water is re-circulated to the fuel supply unit and re-used. The fuel does not need to be diluted with water in advance, leading to a further reduction of the size of the fuel cell.

DMFC systems are disclosed in US 20040166389 and US 20040062964. The latter addresses the issue of condensing water in a heat exchanger of a DMFC system in order to separate it from the exhaust stream of the fuel cell and to re-circulate the water and mix it with the fuel.

However, such downsized fuel cells need efficient heat exchangers in order to prevent damage. Due to corrosion reasons stainless steel is most frequently used as material for fuel cell heat exchangers. According to the state-of-the-art, different types of heat exchangers are used for this purpose. In plate-type heat exchangers, a cathode outlet stream and a cooling air stream are fed over opposite faces of a stainless steel plate, exchanging heat through the plate. A certain number of plates are stacked on top of each other in order to increase the exchanging surface. This type of heat exchanger possesses the problem of difficult integration with a cooling fan, since the cooling air stream has an uneven geometrical distribution. Additional space for flow shaping is needed, leading to a bulky device.

Another type of heat exchangers used are of a tubular type. Here one tube is bent in a serpentine like manner. There are restrictions to the length of these tubes—and accordingly to their surface area—because in order for the stream to be cooled, a certain drop in pressure must not be surpassed. In order to increase the heat exchange rate with the cooling air, metal lamellae are inserted between the tubes to increase the exchange surface. Nevertheless, due to the poor heat conductivity of the heat exchanger material, mainly stainless steel, the performance of this type of device is poor.

Other tube-type heat exchangers use multiple parallel tubes, which are connected through registers attached to the ends of the tubes, directing the flow from one tube to the adjacent one. This type of heat exchanger is disadvantageous because the registers consume considerable space which cannot be used for heat exchangers. In addition, the assembly of the tubes with the registers is costly.

### SUMMARY OF THE INVENTION

The present invention provides a heat exchanger assembly and a method of cooling an outlet stream of a fuel cell using a heat exchanger assembly increasing the efficiency of the heat exchange in fuel cell systems. The present invention also provides a heat exchanger for a fuel cell system and a method of cooling an outlet stream of a fuel cell, especially for a Direct Methanol Fuel Cell (DMFC) system, which provide a minimized volume for a given heat exchange capacity and a low pressure drop for both the cathode stream and the cooling air.

According to an aspect of the present invention, there is provided a heat exchanging assembly for fuel cell systems comprising a heat exchanger and a ventilation unit for generating a stream of cooling air through the heat exchanger, the ventilation unit comprising a circular ventilation means and a housing, the heat exchanger having a width extending in the y-direction, a depth extending in the x-direction, a height extending in the z-direction, a front and a rear, bounded by a plane, extending in the y-z plane, and two sides, bounded by planes, and extending in the x-z plane, wherein the heat exchanger comprises: an inlet manifold with an inlet opening, extending in the x-direction, an outlet manifold with an outlet opening, extending in the x-direction, being spaced apart from the inlet manifold, and a plurality of hollow heat exchanging elements, to allow a flow of a medium contained therein from the inlet manifold to the outlet manifold, the heat exchanging elements extending from the inlet to the outlet in the y-z plane in a serpentine manner, being arranged parallel to each other in the x-direction and spaced-apart to provide empty space between the heat exchanging elements, and comprising first sections extending in the z-direction, and second sections connecting successive first sections, wherein the ventilation unit is arranged parallel to the sides of the heat exchanger extending in the x-z plane, the cooling air flows through the free-space between the heat exchanging elements in an opposite direction to the flow of the medium within the heat exchanging elements, and the diameter of the ventilation means has a value corresponding to at least 66% of the smaller value of either the depth or the height of the heat exchanger.

The diameter of the ventilation means may have a value corresponding to at least 80%, preferable of 90%, even more preferable of 95% of the smaller value of either the depth or the height of the heat exchanger.

The cross section of each of the first sections may have a main axis which is parallel to the flow of cooling air, wherein the width of the cross section along the main axis is greater than the width of the cross section along a second axis perpendicular to the flow of cooling air.

The cross section of the first sections may have an oval shape, the main axis of the oval being arranged parallel to the flow of cooling air.

The outlet manifold may be realized as a water separator for separating condensed water from the medium flowing through the heat exchanger, the outlet manifold being in direct contact to the outlet ends of the heat exchanging elements.

The ventilation unit may be arranged on a downstream side of the heat exchanger and comprises a fan or blower for blowing air from the downstream side to an upstream side of the exchanger, wherein the downstream side is defined as the direction in which the medium flows within the heat exchanging elements.

The ventilation unit may be arranged on an upstream side of the heat exchanger and comprises a fan or blower for sucking air from a downstream side to an upstream side of the exchanger, wherein the upstream side is defined as the direction in which the medium flows within the heat exchanging elements.

The heat exchanging elements may have a tubular structure.

The second sections of the heat exchanging elements may have a u-shaped shaped tubular structure.

The u-shaped tubular structure may consist of straight sections arranged at right angles to each other.

The second sections of the heat exchanging elements may be provided with a straight tubular structure.

The connections between the first sections and the second sections of the heat exchanging elements may be at right angles or substantially right angles.

The middle axis of the tube sections and intersect each other at right angles.

The cross section of the second sections of the heat exchanging elements may have an oval shape.

The ventilation means may comprise a fan or a blower.

The fuel cell system may be a direct methanol fuel cell (DMFC) system.

The inlet of the heat exchanger may be connected to a cathode outlet of a fuel stack of a fuel cell system.

According to another aspect of the present invention, there is provided a method of cooling the outlet stream of a fuel cell using a heat exchanger assembly, the method comprising: guiding the outlet stream of a fuel cell into the inlet of a heat exchanger; guiding the stream from the inlet ends of the heat exchanging elements of the heat exchanger to the outlet ends of the heat exchanger elements, which leads to a cooling effect of the stream; and increasing the cooling effect of the guided stream by providing a flow of cooling air around the heat exchanging elements from the downstream side to the upstream side of the heat exchanger.

The method may further comprise: condensing water within the heat exchanger.

The method may further comprise: separating the condensed water and the air stream in a water separator being in direct contact with the outlet ends of the heat exchanging elements of the heat exchanger.

The method may further comprise: increasing the cooling effect within the heat exchanger by providing the first sections with a cross section whose width in a main axis direction parallel to the flow of cooling air is a greater length than its width in a second axis direction perpendicular to the flow of cooling air.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a fuel cell supply system employing a heat exchanging assembly according to an embodiment of the present invention;

FIG. 2 is a schematic diagram of the heat exchanging assembly according to an embodiment of the present invention;

FIG. 3 is a schematic side view illustrating a heat exchanger illustrated in FIG. 2;

FIG. 4 is a schematic diagram of a heat exchanging assembly according to another embodiment of the present invention; and

FIG. 5 is a schematic diagram of a heat exchanging assembly according to another embodiment of the present invention.

### DETAILED DESCRIPTION OF THE INVENTION

The present invention will now be described more fully with reference to the accompanying drawings in which exemplary embodiments of the invention are shown.

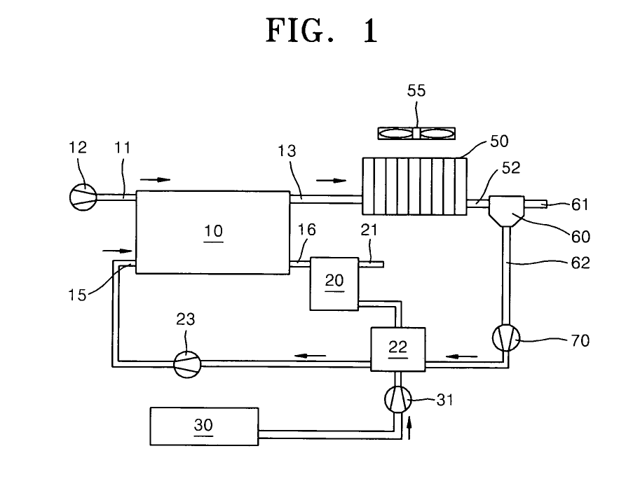

FIG. 1 is a schematic diagram of a fuel cell supply system employing a heat exchanging assembly according to an embodiment of the present invention. Referring to FIG. 1, the fuel cell supply system is realized as a Direct Methanol Fuel Cell (DMFC) system. A fuel cell stack 10 has an air inlet 11 and an air outlet 13. An air pump or fan 12 supplies reaction air to a stack cathode through the air inlet 11. An anode cycle for diluted fuel consisting of a CO₂ separator 20 mounted downstream from a stack fuel outlet 16 removes CO₂ from a reaction stream and vents it to the outside through a venting opening 21. In a mixer 22 the fuel stream is mixed with pure fuel from a fuel tank 30. A fuel pump 23 feeds the diluted fuel back to the fuel inlet 15 of the stack.

A heat exchanger 50 is mounted in the outlet stream of a fuel cell cathode. A ventilation unit 55, e.g. a fan, is used to cool the heat exchanger, leading to cooling of the outlet stream and condensation of water. This two phase flow exits at the outlet 52 of the heat exchanger 50. The ventilation unit 55 and the heat exchanger 50 form the heat exchanging assembly according to the current embodiment of the present invention. Downstream of the heat exchanger 50, a water separator 60 is mounted in order to separate liquid water from the air stream. The separated water is fed back to the anode cycle of the fuel cell system by a condensate pump 70, and the residual air is vented through an outlet 61 to the outside.

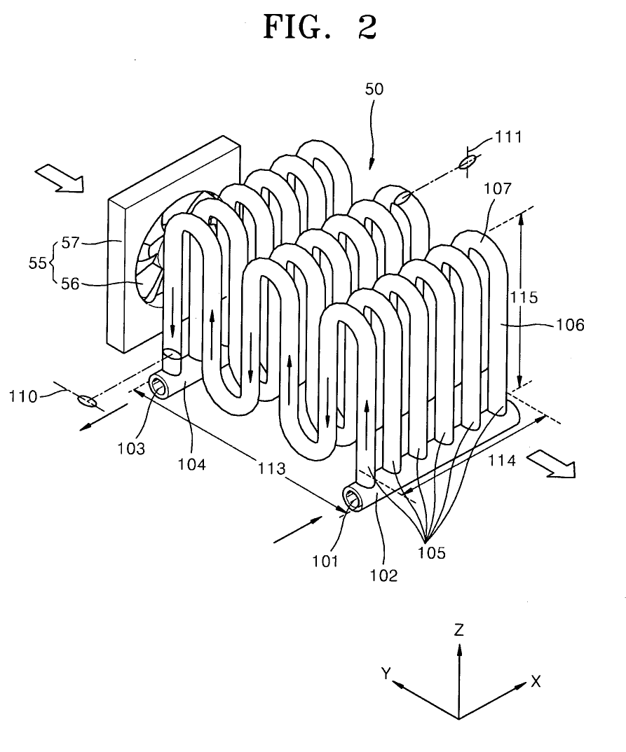

FIG. 2 is a schematic diagram of the heat exchanging assembly according to an embodiment of the present invention. FIG. 2 provides a coordinate system for illustrative purposes of the current embodiment. The surface of the page corresponds to a y-z plane, the x-direction points away from a viewer into the page.

The heat exchanging assembly for fuel cell systems of the present invention comprises a heat exchanger 50 and a ventilation unit 55. The heat exchanger 50 comprises an inlet manifold 102 with an inlet opening 101, an outlet manifold 104 with an outlet opening 103, and a plurality of heat exchanging elements 105 disposed between the inlet opening 101 of the inlet manifold 102 and the outlet opening 103 of the outlet manifold 104 and connecting the inlet manifold 102 and the outlet manifold 104. To maximize the efficiency of heat exchange in the heat exchanger 50, cooling air generated by the ventilation unit 55 flows in the opposite direction to the flow of a medium within the heat exchanging elements 105. The present invention will now be described in detail.

The ventilation unit 55 is used to generate a stream of cooling air through the heat exchanger 50 and comprises a circular ventilation means 56 and a housing 57. The housing 57 can be rectangular or square. The ventilation means 56 is arranged in the housing 57 of the ventilation unit 55 and can be a fan or a blower.

The heat exchanger 50 is a three-dimensional structure and has a width 113 extending in the y-direction, a depth 114 extending in the x-direction, and a height 115 extending in the z-direction as illustrated in FIG. 2. The heat exchanger 50 has a front and a rear, which are both bounded by a plane and extend in the y-z plane. The two side planes of the heat exchanger 50 extend in the x-y plane. The heat exchanger 50 comprises the inlet manifold 102 with the inlet opening 101, which extends in the x-direction, and the outlet manifold 104 with the outlet opening 103, which extends in the x-direction, wherein the outlet manifold 104 is spaced apart from the inlet manifold 102.

The heat exchanger 50 further comprises the plurality of heat exchanging elements 105. The heat exchanging elements have a hollow structure. The hollow structure allows the medium contained in the heat exchanging elements 105 to flow from the inlet manifold 102 to the outlet manifold 104. The heat exchanging elements 105 extend from the inlet 101 to the outlet 103 in the y-z plane in a serpentine manner. The elements 105 are arranged parallel to each other, stacked in the x-direction, and spaced-apart to generate a free space between the heat exchanging elements 105. The heat exchanging elements 105 may be self-supportive. Thus, support plates or other support structures are not necessary. This ensures a formation in which empty space between adjacent heat exchanging elements 105 is maximized. The empty space is necessary to allow a sufficient flow of cooling air generated by the ventilation unit 55 through the heat exchanger 50. The heat exchanging elements 105 comprise first sections 106, extending in the z-direction, and second sections 107, connecting successive first sections 106. The first sections 106 in FIG. 2 are placed upright. Each of the heat exchanging elements 105 comprises a plurality of the first sections 106, which are arranged to be spaced-apart from each other. Each pair of adjacent first sections 106 is connected by the second sections 107, which essentially extend in the y-direction, thereby forming the serpentine structure of the heat exchanging elements 105. This structure allows provides efficient heat exchange due to the large surface for heat exchange.

The heat exchanger 50 exchanges heat of a medium flowing through its heat exchanging elements 105. In the present invention the exhaust gas of the fuel cell 10 enters the inlet opening 101 of the heat exchanger 50. The medium is distributed into the heat exchanging elements 105 connected to the manifold 102 via the inlet manifold 102. The medium flows from the inlet manifold 102 to the outlet manifold 104 and then to the outlet opening 103, through the heat exchanging elements 105. In FIG. 2, the net flow of the medium is in the y-direction, i.e. from right to left. Within each heat exchanging element 105 the medium flows upward in the z-direction through the first sections 106, then to the left in a y-direction through the first second section 107, then downward through the second first section 106, then again to the left through the second sections 107, then upward again through the third first section 106, etc., thereby establishing a net flow of the medium in the y-direction.

In order to increase the heat exchange of the heat exchanger 50, a ventilation unit 55 is arranged parallel to a side of the heat exchanger 50 extending in the x-z plane. The ventilation unit 55 generates a flow of cooling air through the heat exchanger 50. The cooling air flows through the empty space between the heat exchanging elements 105 in the opposite direction to the flow of the medium within the heat exchanging elements 105. Thus, the ventilation unit 55 is provided in a counterflow arrangement respective to the flow of the medium within the heat exchanger 50. In the above structure, the medium within the heat exchanger 50 flows in the opposite direction to the flow of the cooling air generated by the ventilation unit 55, thereby remarkably increasing the efficiency of heat exchange in the heat exchanger 50.

In particular, in order to ensure an efficient cooling effect, the diameter of the ventilation means 56 has a value corresponding to at least 66% of the smaller value of either the depth 114 or the height 115 of the heat exchanger 50. Preferably, the diameter of the ventilation means 56 has a value corresponding to at least 80%, more preferably of 90%, even more preferably of 95% of the smaller value of either the depth 114 or the height 115 of the heat exchanger 50. The diameter preferably does not exceed 150% of the larger value of either the depth 114 or the height 115, more preferably 120%, even more preferably 100%.

In the current embodiment as illustrated in FIG. 2, the ventilation unit 55 is realized as a fan or blower being located on the downstream side with respect to the flow of the medium within the heat exchanger 50. The upstream side is defined as the side of the heat exchanger 50 connected to the inlet 101. Correspondingly, the downstream side is the side of the heat exchanger 50 connected with the outlet 103. The ventilation unit 55 forms a cooling air stream from the downstream side to the upstream side of the heat exchanger 50 as shown in FIG. 2. In order to save space, the ventilation unit 55 is arranged directly adjacent to the downstream side of the heat exchanger 50.

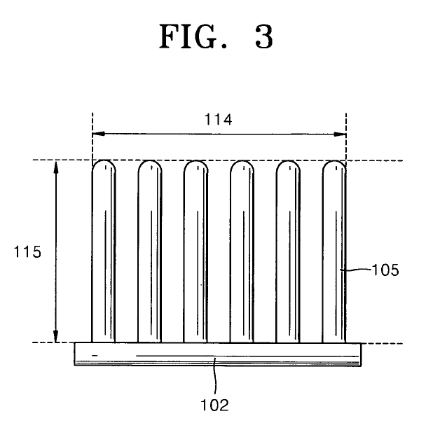

FIG. 3 is a schematic side view illustrating the heat exchanger 50 illustrated in FIG. 2. Referring to FIG. 3, the height 115 of the heat exchanger 50 is defined as the distance between the top of a heat exchanger element 115 and the top of the outlet manifold 102, i.e. the location where the bottom of the heat exchanger element 105 merges with the outlet manifold 102. The depth 114 of the heat exchanger 50 is defined as the distance between the outer edge of the first heat exchanging element 105 and the outer edge of the last heat exchanging element 105 of the heat exchanger 50.

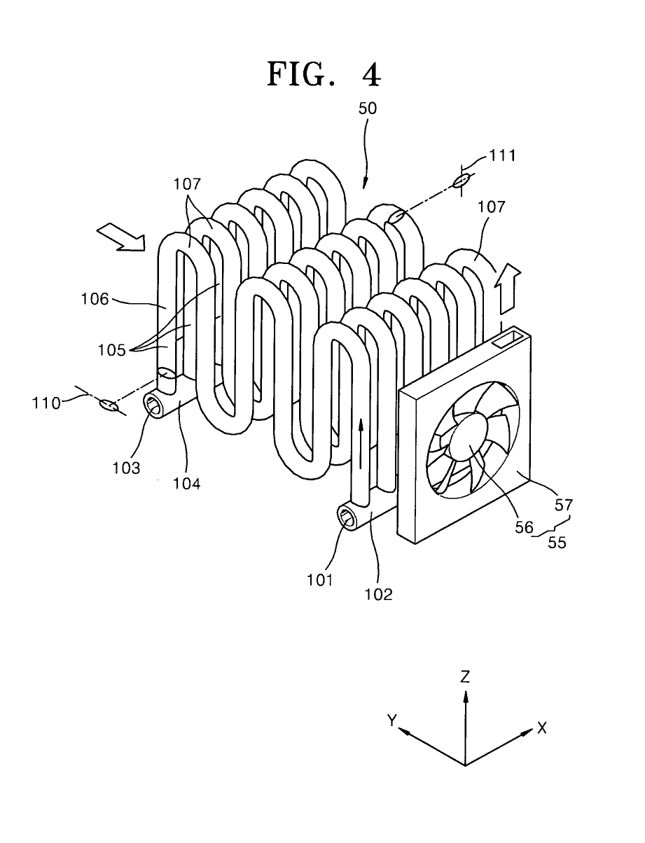

FIG. 4 is a schematic diagram of a heat exchanging assembly according to another embodiment of the present invention. Referring to FIG. 4, a ventilation means 56 is realized as a radial fan or blower located on the upstream side of a heat exchanger 50. The ventilation means 56 sucks in air to form a cooling air stream from the downstream side to the upstream side of the exhaust stream in the heat exchanging elements 105, and preferably blows the air out in a perpendicular direction, i.e. in a z-direction.

The ventilation means 56 of the ventilation unit 55 can comprise a fan or blower, e.g. an axial fan or a radial blower or any other device which is able to produce a specially extended flow of air.

The stream of exhaust gas coming from a fuel stack 10 connected to the inlet 101 of the heat exchanger 50 flows in the positive y-direction, whereas the cooling air flows in the negative y-direction as illustrated in FIG. 4. An outlet opening 103 is connected to a water separator 60. During the gas flow from the inlet 101 via a manifold 102 through the plurality of heat exchanging elements 105 to an outlet manifold 104 and an outlet 103, the exhaust stream is cooled through the surface of the heat exchanging elements 105. The counterflow cooling air stream from the fan or blower 55 enhances the cooling effect. The cooling air stream flows through the heat exchanger 50 and passes the at least one heat exchanging element 105 thereby providing a cooling effect through the surface of the at least one heat exchanging element 105.

In order to reduce the flow resistance to the cooling air stream, the cross section of the tubes can have an oval shape 110 at least in the straight sections 106, wherein the main axis of the oval shape 110 is parallel to the flow direction of the cooling air.

Both for manufacturing and aerodynamic reasons it is advantageous when the tubes in a U-turn section 107 also have an oval shape, wherein the main axis of an oval cross section 111 is perpendicular to both the cooling air flow and the straight sections 106 of the tubes.

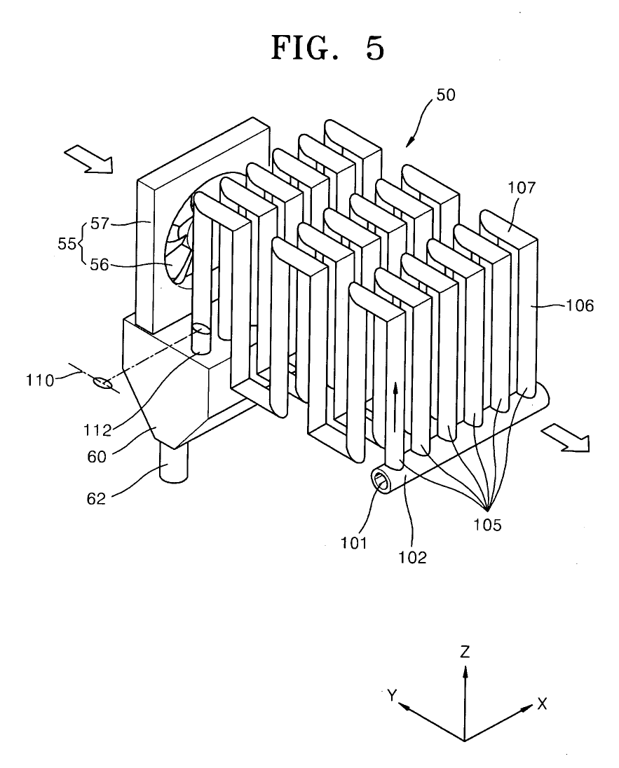

FIG. 5 is a schematic diagram of a heat exchanging assembly according to another embodiment of the present invention. Referring to FIG. 5, in order to have shorter U-turn sections 107 the tubes are manufactured with essentially perpendicular angles, i.e. the angles between the respective middle axes of the tube sections are such that the respective tube sections are essentially rectangular. The u-shape is formed by two extended parallel straight sections 106 with an interposed short section 107 being essentially straight and arranged perpendicular between the two sections 106 so as to combine the sections 106. However, in another embodiment the first and second sections 106 and 107 are both provided as straight tubular sections arranged perpendicular to each other. In one embodiment at least the straight sections 106 may have an oval cross section with the main axis of the oval 110 being parallel to the cooling air flow.

In order to save space the outlet ends of the tubes 112 are connected directly to a water separator 60. The top of the water separator 60 is structured to allow all outlet ends 112 of the heat exchanging elements 112 to merge into the water separator 60. The water separator 60 has a converging structure from its top to its bottom. The bottom of the water separator 60 includes a spout connected to a water feedback connection 62, see FIG. 1.

The material of the tubes in the present invention may be stainless steel in the first instance, but also titanium or plastic. The tubular structure of the present invention may be self-supportive to maximise free-space between the parallel heat exchanging elements 105.

As described above, according to a heat exchanger assembly and a method of cooling the outlet stream of a fuel cell using the heat exchanger assembly, which provide a minimized volume for a given heat exchange capacity, a low pressure drop for the cooling air due to a linear exterior profile of heat exchange elements and a low pressure drop for the cathode stream due to a plurality of the heat exchange elements which are parallel to each other and connected through a manifold, and provide excellent reciprocal communication with a cooling fan.

Although the invention has been described with reference to certain embodiments of the invention, the invention is not limited to these embodiments. In particular, the invention is not limited to DMFC fuel cell systems. It is also clear to one skilled in the art that the heat exchanging assembly can be rotated in space. Through modifications and variations of the embodiments, additional embodiments can be realized without departing from the scope of the invention.

What is claimed is:

1. A heat exchanging assembly for fuel cell systems comprising a heat exchanger and a ventilation unit for cooling the heat exchanger,
wherein the heat exchanger comprises: an inlet manifold with an inlet opening, an outlet manifold with an outlet opening, and a plurality of heat exchanging elements disposed between the inlet opening of the inlet manifold and the outlet opening of the outlet manifold and connecting the inlet manifold and the outlet manifold, and
wherein cooling air generated by the ventilation unit flows in the opposite direction to the flow of a medium within the heat exchanging elements.

2. The heat exchanging assembly according to claim 1, wherein the ventilation unit is disposed in one side of the heat exchanger.

3. The heat exchanging assembly according to claim 1, wherein the ventilation comprises a ventilation means and a housing.

4. The heat exchanging assembly according to claim 1, wherein the plurality of heat exchanging elements has a structure in which a plurality of curved tubes are arranged parallel to each other.

5. The heat exchanging assembly according to claim 4, wherein each of the curved tubes of the heat exchanging elements comprises first sections extending in a direction and second sections connecting ends of adjacent first sections.

6. The heat exchanging assembly according to claim 5, wherein the plurality of curved tubes are arranged along another direction perpendicular to the direction.

7. The heat exchanging assembly according to claim 5, wherein the cross section of each of the first sections has a main axis which is parallel to the flow of cooling air and a second axis perpendicular to the flow of cooling air, wherein main axis is longer than the second axis.

8. The heat exchanging assembly according to claim 5, wherein the second sections of the heat exchanging elements have a u-shaped tubular structure.

9. The heat exchanging assembly according to claim 8, wherein the u-shaped tubular structure consists of straight sections arranged at right angles to each other.

10. The heat exchanging assembly according to claim 5, wherein the second sections of the heat exchanging elements are provided with a straight tubular structure.

11. The heat exchanging assembly according to claim 5, wherein the connections between the first sections and the second sections of the heat exchanging elements are at right angles.

12. The heat exchanging assembly according to claim 5, wherein the middle axis of the tube sections and intersect each other at right angles.

13. The heat exchanging assembly according to claim 5, wherein the cross section of the second sections of the heat exchanging elements have an oval shape.

14. The heat exchanging assembly according to claim 1, wherein the heat exchanger a width extending in a y-direction, a depth extending in an x-direction, and a height extending in a z-direction, and a width or the diameter of the ventilation means has a value corresponding to at least 66% of the smaller value of either the depth or the height of the heat exchanger.

15. The heat exchanging assembly according to claim 14, wherein a width or the diameter of the ventilation means has a value corresponding to at least 80%, preferable of 90%, even more preferable of 95% of the smaller value of either the depth or the height of the heat exchanger.

16. The heat exchanging assembly according to claim 1, wherein the outlet manifold is realized as a water separator for separating condensed water from the medium flowing through the heat exchanger, the outlet manifold being in direct contact to the outlet ends of the heat exchanging elements.

17. The heat exchanging assembly according to claim 1, wherein the ventilation unit is arranged on a downstream side of the heat exchanger and comprises a fan or blower for blowing air from the downstream side to an upstream side of the exchanger, wherein the downstream side is defined as the direction in which the medium flows within the heat exchanging elements.

18. The heat exchanging assembly according to claim 1, wherein the ventilation unit is arranged on an upstream side of the heat exchanger and comprises a fan or blower for sucking air from a downstream side to an upstream side of the exchanger, wherein the upstream side is defined as the direction in which the medium flows within the heat exchanging elements.

19. The heat exchanging assembly according to claim 1, wherein the heat exchanging elements have a tubular structure.

20. The heat exchanging assembly according to claim 1, wherein the ventilation means comprises a fan or a blower.

21. The heat exchanging assembly according to claim 1, wherein the inlet of the heat exchanger is connected to a cathode outlet of a fuel stack of a fuel cell system.
